(19) United States
(12) Patent Application Publication
(10) Pub. No.: US 2024/0293994 A1
(43) Pub. Date: Sep. 5, 2024

(54) LIGHTWEIGHT MULTILAYER SUBSTRATES

(71) Applicant: Interfacial Consultants LLC, Prescott, WI (US)

(72) Inventors: Jeffrey J. Cernohous, Hudson, WI (US); Robert Boyd Andrews, Atlanta, GA (US); Micah Callies, Englewood, CO (US); Gary Hobbs, Springdale, AR (US); Adriano Spinaci, Oakdale, MN (US)

(21) Appl. No.: 18/275,772

(22) PCT Filed: Feb. 2, 2022
(86) PCT No.: PCT/US2022/014882

§ 371 Date: Aug. 3, 2023

Related U.S. Application Data
(60) Provisional application No. 63/145,874, filed on Feb. 4, 2021.

(51) Int. Cl. B32B 5/02; B32B 7/12; B32B 15/14; B32B 15/20; B32B 37/06; B32B 37/10

(52) U.S. Cl. CPC B32B 5/022; B32B 7/12; B32B 15/14; B32B 15/20; B32B 37/06; B32B 37/1027; B32B 2305/20; B32B 2311/24; B32B 2398/20

(57) ABSTRACT

A lightweight multilayer substrate comprising a thermally compressed nonwoven core having a first surface and an opposed second surface, at least one top layer adhered to the first surface of the thermally compressed nonwoven core, and, optionally, at least one bottom layer adhered to the opposed second surface of the thermally compressed nonwoven core. The lightweight multilayer substrate has a specific modulus greater than 1200 (MPa/(g/cm3)) and a thermal expansion coefficient of less than 3×10″5 m/(m*° C.). The lightweight multilayer substrate is thermally balanced between 25° C. and 70° C.

### CROSS-REFERENCE TO RELATED APPLICATION

This application claims priority to U.S. Provisional Application No. 63/145,874 filed Feb. 4, 2021, which is hereby incorporated by reference.

### TECHNICAL FIELD

A lightweight multilayer substrate comprising a thermally compressed nonwoven core having a first surface and an opposed second surface, at least one top layer adhered to the first surface of the thermally compressed nonwoven core, and, optionally, at least one bottom layer adhered to the opposed second surface of the thermally compressed nonwoven core. The lightweight multilayer substrate of this disclosure has a specific modulus greater than 1200 (MPa/(g/cm³)) and a thermal expansion coefficient (“TEC”) of less than 3×10⁻⁵ m/(m*° C.). The lightweight multilayer substrate of this disclosure is thermally balanced between 25° C. and 70° C. In one embodiment, at least one of the top or bottom layers comprises a reinforcing layer. In another embodiment, at least one of the top or bottom layers comprises an antiskid layer. The unique characteristics of the lightweight multilayer substrates of this disclosure allow for a substantially improved mechanical and thermal properties over conventional thermoplastic substrates known in the art.

### BACKGROUND

Substrates derived from thermoplastic polymers are well known, among other things, to offer the advantages of good stiffness, chemical resistance, ability to be formed into various shapes, and relatively low cost. Unfortunately, this class of polymers is also known to possess relatively high thermal expansion values. Values found in the literature for common thermoplastics such as polyethylene, polypropylene, PVC, polyester, and nylon typically range from 5×10⁻⁵ m/(m*° C.) to 25×10⁻⁵ m/(m*° C.). Those of ordinary skill in the art of plastics fully appreciate the importance of using materials with low TECs when designing a plastic article for applications that involve a change of temperature.

Materials with low TECs are highly desirable in a number of markets including flooring, building and construction, industrial, transportation, and automotive to name a few. A low TEC is desirable in these markets because it allows for a material to be used over wider temperature ranges without causing problems such as bending, buckling, breaking, or debonding.

Flooring, particularly those applications in the building and construction or transportation industry, are representative applications where a low TEC is desired and important. Temperature changes within a room are well known by those skilled in the art to cause problems with buckling, shrinkage, or debonding of a multilayer flooring laminate from the subfloor to which it has been glued when the temperature change becomes too great. These temperature changes may be caused by changing conditions such as ambient air temperature changes, subfloor temperature changes, radiant sunlight warming a location of the floor, or having the flooring installed at a temperature that is significantly different than the temperature it will be used at. Each issue can result in aesthetically unacceptable appearances for customers desiring a decorative floor covering.

Wood and wood resin composites are known for their very low TECs. However, wood and wood resin composites are known to suffer from sensitivity to moisture in the form of liquid water or humidity in the air. Too much exposure to water is known to cause swelling in wood-based flooring and results in similar aesthetic issues that are described above. Most plastics are not sensitive to swelling caused by water because they are inherently non-polar in nature unless they are filled with natural fillers that can absorb water.

Replacing PVC or wood with a plastic such as polyethylene or polypropylene is especially challenging because these polymeric resins have an inherently higher TEC that would need to be dramatically reduced to meet or exceed the TECs found in materials used for LVT, other flooring applications, and applications such as ceiling tiles, wall coverings, decking materials and other such applications.

Despite the various challenges, for many years the global market, led by environmental concerns related to PVC or water absorption challenges related to wood, has sought replacements for PVC and wood in a wide variety of markets including flooring. Environmental concerns about PVC include its end-of-life properties where it has the potential to break down into HCl or dioxins if not properly disposed of. Additionally, phthalate plasticizers, regularly used to soften rigid PVC to make it more useful in a number of applications including flooring, have also been cause for concern as they have been linked to various potential health issues and have been observed to migrate into humans. Additionally, highly filled PVC that is often used in flooring applications, is difficult to recycle and reuse. Wood products are known to suffer from decay, swelling, and rotting when exposed to too much water over time.

There have been attempts to address the noted challenges with PVC, particularly in the flooring market. For example, various alternatives have been pursued with other polymers and polymeric composites. Polyolefins such as low density polyethylene (“LDPE”), high density polyethylene (“HDPE”), polypropylene (“PP”), and other similar polyolefins offer a potential alternative because of their availability, excellent melt processability, relatively low cost, and their ability to be recycled. Similarly, reclaimed plastics based upon plastics collected from reclaimed articles such as carpet, plastic-coated papers, municipal waste, and industrial scrap have also been considered and are similarly based on LDPE, HDPE, PP, other similar polyolefins, as well as nylon, polyester and PVC and mixtures thereof.

The TECs of LDPE and HDPE homopolymers are typically about three times the TEC of neat PVC. Neat PP has a lower TEC that depends upon its molecular orientation and can range from 1.5 to 2.5 times the TEC of neat PVC. Another challenge for polyolefins such as LDPE, HDPE, and PP is, that when compared to neat PVC, none can be as efficiently filled as highly as PVC with fillers that effectively reduce the TEC of the neat resins. This challenge is applied to reclaimed polymeric materials as well.

Conventional efforts to lower the TECs of thermoplastics involve making composites by the incorporation of various fillers. Fillers can include mineral fillers such as calcium carbonate, talc, clay, volcanic ash or various nanoparticles. Fillers can also include organic fillers such as wood flour, rice hulls, or corn byproducts. It is also known to employ fibers such a carbon fibers, various polymer fibers, cellulose fibers, or glass fibers and combine them with polymer melt processing techniques to form thermoplastic composites. Such fibers may be incorporated as loose fibers or orientated fibers in the polymer or as woven or nonwoven sheets. The woven or nonwoven sheets are often first made into relatively thin webs of a low basis weight that have thermoplastic or thermoset polymers incorporated into them. They are then typically applied as layers to ultimately create a multilayer substrate. Unfortunately, the addition of excessive filler or fibers in an effort to achieve lower TECs can compromise other properties of thermoplastic composites. For example, the resulting composite may undesirably exhibit the reduction of one or more of its weight, overall flexibility, cost, or impact strength. It can also become very difficult to mix high amounts of fillers into thermoplastics.

The TEC of thermoplastic composite materials is very dependent on the thermoplastic resin being used. Thermoplastic resins such as polyethylene and polypropylene, which have high TECs, are more difficult to modify into thermoplastic composites having a very low TEC. Thermoplastics such as PVC and polyester have lower TECs than polyolefins. However, there remains a need in the marketplace for thermoplastic composites having even lower TECs than presently available.

This disclosure is directed to solutions to the market needs for cost-effective, lightweight substrates possessing exceptionally low TECs and outstanding mechanical properties for applications such as flooring, including LVT, ceiling coverings, wall coverings, exterior decking materials, and the like and a method of manufacturing that enables the solution as well as provides for required flatness in the resultant product.

### SUMMARY

The disclosure described herein discloses lightweight multilayer substrates with an outstanding combination of properties, specifically TEC, specific modulus, and low specific gravity. More specifically, the lightweight multilayer substrates of this disclosure comprise a thermally compressed nonwoven core having a first surface and an opposed second surface, at least one top layer adhered to the first surface of the thermally compressed nonwoven core, and, optionally, at least one bottom layer adhered to the opposed second surface of the thermally compressed nonwoven core. The lightweight multilayer substrates of this disclosure have a specific modulus greater than 1200 (MPa/(g/cm³)) and a TEC of less than 3×10⁻⁵ m/(m*° C.). The lightweight multilayer substrates of this disclosure are thermally balanced between 25° C. and 70° C. The unique characteristics of the lightweight multilayer substrates of this disclosure allow for a substantially improved mechanical and thermal properties over conventional thermoplastic substrates known in the art.

In one embodiment, at least one of the top or bottom layers of the lightweight multilayer substrate comprises a reinforcing layer. In some embodiments, the reinforcing layer comprises a fiberglass mat that may be described as having an open weave. The open weave of the fiberglass mat bonds to the nonwoven core during the thermal compression process. Embodiments may include fiberglass mats with a weight between 76 g/m² and 1500 g/m², or in certain applications, between 150 g/m² and 600 g/m². Additionally, the open weave of the fiberglass mat may be characterized by having between 20 and 3000 glass intersections within one square centimeter. In another embodiment, the reinforcing layer is a unidirectional tape comprised of a thermoplastic embedded with continuous glass or carbon fiber.

In another embodiment, at least one of the top or bottom layers of the lightweight multilayer substrate comprises an antiskid layer. The antiskid layer has the effect of improving the coefficient of friction between the lightweight multilayer substrate and another surface or object in contact with that surface. In one embodiment, non-limiting examples of antiskid layers include thermoplastic polyolefins (TPO), polyurethanes, thermoplastic polyurethanes, polyolefin elastomers (POEs), thermoplastic elastomers (TPEs), polyureas, and copolyesters. In yet another embodiment, at least one of the top or bottom layers of the lightweight multilayer substrate comprises a reinforcing layer and an antiskid layer.

One method for producing a lightweight multilayer substrate of this disclosure involves thermal compression bonding. Unlike other melt processing practices, thermal compression bonding does not require a precise melt state and operates at low pressure and low shear. One example of thermal compression bonding is a continuous double belt press. The continuous double belt press produces a substrate of a selected width and thickness and of indefinite length. In accordance with this disclosure, the continuous double belt press is operated at low pressure so as to enable the concurrent thermal compression and lamination of the nonwoven core and the top and/or bottom layers. This results in a lightweight multilayer substrate that has an exceptional balance of properties. The thicknesses of the resulting lightweight multilayer substrate can range having an overall thickness of between approximately 2 mm and 50 mm.

The resultant lightweight multilayer substrates can be used alone or as a component for many applications in the transportation and building and construction markets including flooring, ceiling, roofing, door panels, load floors, headliners, wall coverings, countertops, exterior decks, and other such substrate applications for which thermoplastic materials having low TECs are desired. In one embodiment, the resulting lightweight multilayer substrates of this disclosure can be either thermoformed or vacuum formed into a three-dimensional article.

### DETAILED DESCRIPTION

The following terms used in this application are defined as follows:

The terms “a,” “an,” “the,” “at least one,” and “one or more” are used interchangeably. Thus, for example, a lightweight multilayer substrate containing “a” reinforcing layer means that the lightweight multilayer substrate may include “one or more” reinforcing layer.

The term “antiskid layer” means one or more surface layers of the lightweight multilayer substrate that act to increase the coefficient of friction of the lightweight multilayer substrate.

The term “composite” means a mixture of a polymeric material and one or more additional materials.

The term “lightweight multilayer substrate” means a substrate, that is thermally balanced between 25° C. and 70° C., comprising a thermally compressed nonwoven core having a first surface and an opposed second surface, at least one top layer adhered to the first surface, and, optionally, at least one bottom layer adhered to the opposed second surface.

The term “nonwoven core” means one or more thermoplastic fibers bonded together into a substrate by chemical, mechanical, heat, or solvent treatment.

The term “reinforcing layer” means one or more layers that when bonded to a thermally compressed nonwoven core have the effect of increasing the specific modulus of the lightweight multilayer substrate.

The term “specific modulus” means the value calculated by dividing the flexural modulus (MPa) by the specific gravity (g/cm³).

The term “substrate” means an object of a selected width, thickness, and length.

The term “thermally balanced” means a substrate that maintains flatness within a temperature range of 25° C. to 70° C., as measured by edge lift test.

The term “thermally compressed” means to process a substrate at pressures above 1 bar and temperatures above the glass transition temperature of at least one of the thermoplastic fibers of the nonwoven core, but below the melting temperatures of the thermoplastic fibers of the nonwoven core.

The recitation of numerical ranges using endpoints includes all numbers subsumed within that range (e.g., 1 to 5 includes 1, 1.5, 3, 3.95, 4.2, 5, etc.).

The lightweight multilayer substrates of this disclosure comprise a thermally compressed nonwoven core having a first surface and an opposed second surface, at least one top layer adhered to the first surface of the thermally compressed nonwoven core, and at least one bottom layer adhered to the opposed second surface of the thermally compressed nonwoven core. The lightweight multilayer substrates have a specific modulus greater than 1200 (MPa/(g/cm³)) and a TEC of less than 3×10⁻⁵ m/(m*° C.). The lightweight multilayer substrates are thermally balanced between 25° C. and 70° C.

The lightweight multilayer substrates of this disclosure are derived from a nonwoven core. The nonwoven core is comprised of at least one thermoplastic fiber layer. The thermoplastic fiber layer is comprised of thermoplastic fibers bonded together by chemical, mechanical, heat, or solvent treatment. Non-limiting examples of thermoplastic fibers useful in a thermoplastic fiber layer of the nonwoven core include polyesters, polyamides, polyolefins, or combinations thereof. Additional examples of thermoplastic fibers of this disclosure include polyethylene terephthalate (PET), amorphous polyethylene terephthalate (aPET), and polypropylene.

The nonwoven core of this disclosure is thermally compressed at elevated temperatures and pressures to increase the specific gravity and flexural modulus of the nonwoven core. To thermally compress the nonwoven core effectively, the temperature should be above the glass transition temperature of at least one of the thermoplastic fibers within the nonwoven core, but below the melting temperatures of at least one of the thermoplastic fibers within the nonwoven core. If the temperature is too high, such that it is approaching or above the melting point of the thermoplastic fibers of the nonwoven core, the nonwoven core and the resulting substrate can shrink as much as 50% during thermal compression. In one embodiment, the shrinkage during thermal compression of the nonwoven core and the resulting substrate is less than 10%. In one embodiment, the shrinkage of the nonwoven core and the resulting substrate during thermal compression is less than 5%. In another embodiment, the specific gravity of the thermally compressed nonwoven core is between 0.2 g/cm³ and 0.7 g/cm³. In yet another embodiment, the specific gravity of the thermally compressed nonwoven core is between 0.3 g/cm³ and 0.5 g/cm³.

Nonwoven cores of this disclosure are often described by the mass of the nonwoven core per unit area (g/m² or gsm), regardless of thickness. In one embodiment, the nonwoven core has a mass between 500 g/m² and 5000 g/m². In another embodiment, the nonwoven core has a mass between 700 g/m² and 4000 g/m². In yet another embodiment, the nonwoven core has a mass between 1000 g/m² and 3500 g/m². To achieve the desired nonwoven core mass, it is possible to thermally compress a single thermoplastic fiber layer or multiple thermoplastic fiber layers of lower mass. For example, it is possible to use three thermoplastic fiber layers, each having a mass of 1000 g/m², during thermal compression to create a nonwoven core having a final mass of 3000 g/m². Non-limiting examples of nonwoven cores useful in this disclosure include those commercially produced by Dalco Nonwovens Corp. (Connover, NC).

Nonwoven cores of this disclosure have a first surface and an opposed second surface, at least one top layer adhered to the first surface, and at least one bottom layer adhered to the opposed second surface. In one embodiment, at least one of the top or bottom layers of the lightweight multilayer substrate comprises a reinforcing layer. The reinforcing layers of this disclosure are adhered to the nonwoven core during thermal compression. Non-limiting examples of reinforcing layers useful in this disclosure include fiber reinforced thermoplastics, unidirectional tapes, fiberglass mats, and carbon fiber mats. Some embodiments comprise a fiberglass mat that may be described as having an open weave. The open weave of the fiberglass mat bonds to the nonwoven core during the thermal compression process. Embodiments may include fiberglass mats with a weight between 76 g/m² and 1500 g/m², or in certain applications, between 150 g/m² and 600 g/m². Additionally, the open weave of the fiberglass mat may be characterized by having between 20 and 3000 glass intersections within one square centimeter, including those commercially available from Superior Huntingdon Composites.

In other embodiments, the reinforcing layers can be comprised of metallic solid sheets, foils, films, perforated sheets, expanded metals, as well as wire mesh and cloth forms. Non-limiting examples of readily available metals in suitable forms include copper, aluminum, brass, bronze, cobalt, gold, silver, lead, molybdenum, nickel, platinum, steel, stainless steel, tantalum, tin, and zinc. The thickness of the metallic reinforcing layer can be varied but is typically between 0.01 and 1 mm. In one embodiment, the thickness of the metal film is between 0.05 and 0.5 mm. In another embodiment, the reinforcing layers are comprised of aluminum sheets to form aluminum composite panels (ACP). ACP is commonly used in building and construction applications as a wall covering and cladding material. In addition to exceptional stiffness to weight and low TEC, ACP can be decorated by a wide variety of different coating and printing methods for interior and exterior uses.

Metallic reinforcing layers generally require some conventional processing for adhesion promotion to the thermally compressed nonwoven core. Non-limiting examples of conventional strategies to improve adhesion include mechanical scuffing, deoxidation, coating, or tie-layers. Tie-layers are useful method for improving adhesion between the thermally compressed nonwoven core and the metallic reinforcing layer as it can be achieved during thermal compression of the multilayer substrate. Non-limiting examples of tie-layers include hot melt adhesives, pressure sensitive adhesives, and functionalized polymer films. Non-limiting examples of hot melt adhesives include functionalized polyolefins (e.g., polyethylene vinyl acetate, maleated polyolefin copolymers, styrenic block copolymers, polyolefin block copolymers), polyurethanes, acrylics, and polyolefin copolymers (e.g., polyethylene-hexene copolymers, polyethylene-octene copolymers, polypropylene copolymers). Non-limiting examples of pressure sensitive adhesives include those derived from acrylic copolymers, styrenic block copolymers, natural rubber, silicones, and polyolefin copolymers. Non-limiting examples of functionalized polymer films include polyolefin copolymers and reactive polyolefin copolymers. A specific example of a tie-layer is a maleated polyolefin copolymer, Linxidan 4433, commercially available from Saco Polymers (Sheboygan, WI).

A continuous filament mat (“CFM”) can also be utilized as a reinforcing layer. A CFM is a reinforcing mat composed of continuous fiberglass strands that are spun to produce a random fiber orientation and bulk. CFMs use continuous long fibers rather than short chopped fibers. CFMs are produced by dispensing molten fiberglass strands directly onto a moving belt in a looping fashion. As the fiberglass strands cool and harden, a binder is applied to hold the fiberglass strands in place. Such CFMs are commercially available from Huntingdon Fiberglass Products, LLC, Huntingdon, PA. Those of ordinary skill in the art with knowledge of this disclosure are capable of selecting a particular fiberglass mat or CFM to obtain a finished product with desired characteristics.

In another embodiment, the reinforcing layer is a unidirectional tape comprised of a thermoplastic matrix embedded with continuous glass or carbon fiber, including those commercially available from Avient Corporation and Ridge Corporation. In some embodiments, the glass content of the unidirectional tape is between 40-80 weight %. In other embodiments, the glass content of the unidirectional tape is between 50-70 weight %. In another embodiment, the thermoplastic matrix of the unidirectional tape is a polyolefin or a polyester. In yet another embodiment, the thermoplastic matrix of the unidirectional tape is polypropylene (PP), low density polyethylene (LDPE), high density polyethylene (HDPE), polyethylene terephthalate (PET), or polyethylene terephthalate glycol (PETG).

In another embodiment, at least one of the top or bottom layers of the lightweight multilayer substrate comprises an antiskid layer. The antiskid layers have the effect of improving the coefficient of friction between the lightweight multilayer substrate and another surface or object in contact with that surface. Non-limiting examples of antiskid layers include thermoplastic polyolefins (TPO), polyurethanes, thermoplastic polyurethanes, polyolefin elastomers (POEs), thermoplastic elastomers (TPEs), polyureas, and copolyesters. Some embodiments include thermoplastic polyolefins, such as those produced by Interfacial Consultants LLC. In one embodiment, the coefficient of friction of the lightweight multilayer substrate is greater than 0.25. In another embodiment, the coefficient of friction of the lightweight multilayer substrate is greater than 0.35. In yet another embodiment, at least one of the top or bottom layers of the lightweight multilayer substrate comprises a reinforcing layer and an antiskid layer.

In one embodiment, a lightweight multilayer substrate comprises a nonwoven core and at least one reinforcing and/or antiskid layer(s) on only one side of the nonwoven core (i.e., only on the top or bottom layer). For a lightweight multilayer substrate of this construction to be thermally balanced, the top or bottom layer, whichever contains the reinforcing and/or antiskid layer(s), must have a TEC that is very close in value to the TEC of the nonwoven core. If this is not the case, the lightweight multilayer substrate will be unbalanced and will deform with temperature changes causing edge lift. In one embodiment, a lightweight multilayer substrate is produced by thermally laminating a nonwoven core to a fiberglass mat and an antiskid layer. By properly selecting the antiskid layer and fiberglass mat, the antiskid layer can melt and flow into the fiberglass mat during processing to produce a composite layer that has a similar TEC to the TEC of the nonwoven core after thermal compression and, as a result, is thermally balanced.

The lightweight multilayer substrates of this disclosure have outstanding stiffness to weight ratio characteristics. One measurement of the stiffness to weight ratio is known as specific modulus. Specific modulus for this purpose is defined as the value calculated by dividing the flexural modulus (MPa) by the specific gravity (g/cm³). Flexural modulus is determined following ASTM D790 test method. Specific gravity is determined using the Archimedes Method. In one embodiment, the specific modulus of the lightweight multilayer substrates is greater than 1200 (MPa/(g/cm³)). In another embodiment, the specific modulus of lightweight multilayer substrates is greater than 1500 (MPa/(g/cm³)). In yet another embodiment, the specific modulus of lightweight multilayer substrates is greater than 2000 (MPa/(g/cm³)).

The lightweight multilayer substrates embodied in this disclosure have an outstanding TEC. In one embodiment, the TEC of the lightweight multilayer substrates is less than 3×10⁻⁵ m/(m*° C.). In another embodiment, the TEC of the lightweight multilayer substrates is less than 1.5×10⁻⁵ m/(m*° C.). TEC is determined using ASTM 6341.

The lightweight multilayer substrates of this disclosure are lightweight. In one embodiment, the specific gravity of the lightweight multilayer substrates is less than 0.80 g/cm³. In another embodiment, the specific gravity of the lightweight multilayer substrates is less than 0.65 g/cm³. Specific gravity is determined using the Archimedes Method.

The lightweight multilayer substrates of this disclosure are thermally balanced. This means that they maintain their flatness through a range of temperatures as measured by the edge lift test. The edge lift test is the measurement of how flat a substrate of specified dimension is. In one embodiment, the edge lift is less than 1 mm (0.50%) for a substrate that is 8 in×8 in. In another embodiment, the edge lift is less than 0.5 mm (0.25%) for an 8 in×8 in substrate.

One method of producing a lightweight multilayer substrate of this disclosure is thermal compression bonding. In certain embodiments, thermal compression bonding on a continuous double belt press produces lightweight multilayer substrates having very low TECs and outstanding mechanical properties. Unlike conventional polymer thermal processing methods, such as extrusion and injection molding, the continuous double belt press process does not require precise melt state properties to create the resultant lightweight multilayer substrate.

A continuous double belt press is a thermal compression manufacturing process that is capable of being used in a continuous manner and applies the temperature needed to thermally compress the nonwoven core and adhere the reinforcing and/or antiskid layers to produce the lightweight multilayer substrate. In one embodiment, the reinforcing and/or antiskid layers can be created by scattering a pellet or powder form of the polymeric composite, compound, or resin constituents of the reinforcing and/or antiskid layers onto the pre-compressed nonwoven core. The continuous double belt press process melts and adheres the reinforcing and/or antiskid layers and compresses the nonwoven core during processing to create a consolidated lightweight multilayer substrate. The continuous double belt press can also be used to thermally bond and compress a reinforcing and/or antiskid layer web to the nonwoven core during processing.

The continuous double belt press process results in very flat lightweight multilayer substrates that vary in thickness less than +/−0.1 mm over a 1 meter distance. The continuous double belt press process can also enable very flat materials over smaller distances to achieve the specification of flatness required in many industries, including the flooring industry. Specifically, the edge lift over a 1 m distance is less than 2 mm.

Continuous double belt presses that are useful in this disclosure utilize two glass reinforced polytetrafluoroethylene (“PTFE”) belts to provide good release properties of the substrate after processing. The continuous double belt presses typically have one or more heating zones and cooling zones. Other parameters that can be adjusted include the belt gap (distance between the top and bottom belts), temperature, and pressure. The continuous double belt presses often have one or more nip rollers that allow higher pressure to be exerted. This higher pressure is referred to as the nip pressure. Finally, the belt speed is typically varied to ensure the proper residence time for heating and cooling to achieve successful lamination and adhesion of each laminate layer.

Those of ordinary skill in the art recognize that pressure applied during the thermal compression bonding process is a variable that has an impact on the properties of the resulting substrate. Sufficient pressure is applied to thermally compress the nonwoven core to a target density and also provide the desired adhesion between the nonwoven core and the reinforcing and/or antiskid layers of the lightweight multilayer substrate. Examples of times, temperatures, and pressures used to produce the lightweight multilayer substrates of this disclosure can be found in the Examples section. Those skilled in the art will know other process conditions that can also be utilized to enable similar results with a continuous double belt press process.

The resulting lightweight multilayer substrates may be treated to enable bonding or attachment of additional layers to create a lightweight multilayer article. Non-limiting examples of such methods known in the art include plasma treatment, corona treatment, silane treatment, use of primer materials, or heat treatment.

The resultant lightweight multilayer substrates can be used alone or as a component for many applications in the transportation and building and construction markets including flooring, ceiling, roofing, door panels, load floors, headliners, wall coverings, countertops, exterior decks, and other such substrate applications for which thermoplastic materials having low TECs are desired. In one embodiment, the resulting lightweight multilayer substrates of this disclosure can be either thermoformed or vacuum formed into a three-dimensional article.

In one embodiment, lightweight multilayer substrates comprising a thermally compressed nonwoven core having a mass between 2000-4000 g/m² and antiskid layers have utility as cargo van flooring and truck bed liners. The balance of weight, TEC, and antiskid performance makes the lightweight multilayer substrates ideal for this application. In another embodiment, lightweight multilayer substrates comprising a thermally compressed nonwoven core having a mass between 2000-5000 g/m² and two reinforcing layers have utility as marine flooring. In this application, high specific modulus, moisture resistance, and low specific gravity are desirable. In another embodiment, lightweight multilayer substrates comprising a thermally compressed nonwoven core having a mass between 500-1000 g/m² and antiskid layers have utility as indoor exercise/gym flooring. In this application, the balance of weight, TEC, and antiskid performance is desirable.

### EXAMPLES

TABLE 1
Materials

| Materials | Description & Supplier |
|---|---|
| Thermoplastic Fiber | 60/40 PET/aPET nonwoven fiber matt, 1330 g/m², |
| Layer 1 (TFL 1) | commercially available from Dalco |
| | Nonwovens Inc., Connover, NC |
| Thermoplastic Fiber | 0.5 in thickness GoBoard, polyisocyanurate foam, |
| Layer 2 (TFL 2) | commercially available from Johns |
| | Manville Inc., Denver, CO |
| Thermoplastic Fiber | 60/40 PP/PET nonwoven fiber matt, 1200 |
| Layer 3 (TFL 3) | g/m², commercially available from |
| | Dalco Nonwovens Inc., Conover, NC |
| Thermoplastic Fiber | 60/40 PET/aPET nonwoven fiber matt, 1200 |
| Layer 4 (TFL 4) | g/m², commercially available from |
| | Dalco Nonwovens Inc., Conover, NC |
| Reinforcing Layer | 0/90 PP/Glass Unidirectional Tape, 60% glass |
| 1 (RL 1) | fiber, commercially available from |
| | Ridge Corporation, Pataskala, OH |
| Reinforcing Layer | 0/90/0 HDPE/Glass Unidirectional Tape, |
| 2 (RL 2) | 70% glass fiber, commercially available from |
| | Avient Corporation, Denver, CO |
| Reinforcing Layer | Nonwoven glass matt, 1 oz/ft², commercially |
| 3 (RL 3) | available from Superior Huntingdon Composites |
| | Corporation, Vanceberg, KY |
| Reinforcing Layer | .025″ thick 3000 series aluminum sheet, |
| 4 (RL 4) | commercially available from McMaster-Carr |
| | Elmhurst, IL |
| LDPE | Recycled LDPE, commercially available from |
| | Deltco Plastics Corporation, Ashland, WI |
| Tie-Layer (TL 1) | Linxidan 4433 Coupling Agent, commercially |
| | available from Saco Polymers, Sheboygan, WI |
| Antiskid Layer | TPO sheet, commercially available from |
| 1 (AL 1) | Interfacial Consultants LLC, Prescott, WI |

### Comparative Example CE1-CE 11 and Examples 1-13

Each of the materials listed in Table 1 were cut into 24 in×24 in sheets. A sample was created for each comparative example and example by stacking the sheets together one on top of the other, according to the specific layer compositions given in Table 2. The thermoplastic fiber layer(s) of each sample make up their nonwoven cores. The samples were processed through a continuous double belt press made by Reliant Machinery of Philadelphia, PA. The continuous double belt press was 71 in wide and configured with approximately 2 m of heating zone and 1 m of cooling zone. The total length of combined heating and cooling zones, which includes length for nip rollers and other mechanical equipment, was approximately 3 m. The unit was electrically heated and cooled by circulating cold water. The specific processing conditions for each comparative example and example are given in Table 3. The resulting composite samples were characterized for flexural properties following ASTM D790 test method. The resulting composite samples were characterized for specific gravity using the Archimedes Method. The TEC of each resultant composite sample was determined using ASTM 6341. The edge lift of each resultant composite sample was determined by cutting an 8 in×8 in piece from each resulting composite sample and measuring the distance that each corner lifted off of a flat surface. The average edge lift equals the summation of the edge lift for each corner. The experimental results for each comparative example and example are given in Table 4.

TABLE 2
Composite Layer Composition for CE1-CE11 and Examples 1-13

| Example | Layer 1 | Layer 2 | Layer 3 | Layer 4 | Layer 5 | Layer 6 |
|---|---|---|---|---|---|---|
| CE1 | TFL 1 | TFL 1 | — | — | — | — |
| CE2 | TFL 1 | TFL 1 | — | — | — | — |
| CE3 | TFL 1 | TFL 1 | — | — | — | — |
| CE4 | AL 1 | TFL 3 | TFL 3 | — | — | — |
| CE5 | AL 1 | RL 1 | TFL 3 | TFL 3 | — | — |
| CE6 | AL 1 | TFL 3 | RL 1 | TFL 3 | — | — |
| CE7 | AL 1 | TFL 3 | TFL 3 | RL 1 | — | — |
| CE8 | AL 1 | RL 1 | TFL 3 | TFL 3 | RL 1 | — |
| CE9 | AL 1 | TFL 3 | RL 1 | TFL 3 | RL 1 | — |
| CE10 | TFL4 | — | — | — | — | — |
| CE11 | TFL4 | TFL4 | — | — | — | — |
| 1 | RL 1 | TFL 3 | TFL 3 | RL 1 | — | — |
| 2 | RL 2 | TFL 3 | TFL 3 | RL 2 | — | — |
| 3 | AL 1 | TFL 2 | — | — | — | — |
| 4 | AL 1 | TFL 2 | AL 1 | — | — | — |
| 5 | AL 1 | RL 1 | TFL 1 | TFL 1 | RL 1 | AL 1 |
| 6 | AL 1 | RL 2 | TFL 1 | TFL 1 | RL 2 | AL 1 |
| 7 | RL1 | TFL3 | RL1 | TFL3 | RL1 | — |
| 8 | AL 1 | RL3 | TFL 3 | TFL 3 | — | — |
| 9 | AL 1 | RL3 | TFL 3 | TFL 3 | TFL 3 | — |
| 10 | AL 1 | TFL 3 | TFL 3 | TFL 3 | AL 1 | — |
| 11 | RL4 | TFL4 | RL4 | — | — | — |
| 12 | RL4 | TFL4 | TFL4 | RL4 | — | — |
| 13 | RL4 | TFL4 | TL4 | RL2 | — | — |

TABLE 3
Processing Conditions for CE1-CE11 and Examples 1-13

| | Heating | Cooling | | | | |
|---|---|---|---|---|---|---|
| | Zone | Zone | | | | |
| | Temper- | Temper- | Belt | Nip | Nip | Belt |
| | ature | ature | Gap | Gap | Pressure | Speed |
| Example | (° C.) | (° C.) | (mm) | (mm) | (Bar) | (m/min) |
| CE1 | 150 | 20 | 8 | 8 | 2 | 0.5 |
| CE2 | 150 | 20 | 6 | 6 | 2 | 0.5 |
| CE3 | 150 | 20 | 4 | 4 | 2 | 0.5 |
| CE4 | 150 | 20 | 8 | 8 | 2 | 0.5 |
| CE5 | 150 | 20 | 8 | 8 | 2 | 0.5 |
| CE6 | 150 | 20 | 8 | 8 | 2 | 0.5 |
| CE7 | 150 | 20 | 8 | 8 | 2 | 0.5 |
| CE8 | 150 | 20 | 8 | 8 | 2 | 0.5 |
| CE9 | 150 | 20 | 8 | 8 | 2 | 0.5 |
| CE10 | 180 | 20 | 3 | 2.5 | 2 | 0.7 |
| CE11 | 180 | 20 | 7 | 6.5 | 2 | 0.7 |
| 1 | 150 | 20 | 8 | 8 | 2 | 0.5 |
| 2 | 150 | 20 | 8 | 8 | 2 | 0.5 |
| 3 | 150 | 20 | 12.5 | 12.5 | 2 | 0.5 |
| 4 | 150 | 20 | 12.5 | 12.5 | 2 | 0.5 |
| 5 | 150 | 20 | 8 | 8 | 2 | 0.5 |
| 6 | 150 | 20 | 8 | 8 | 2 | 0.5 |
| 7 | 150 | 20 | 8 | 8 | 2 | 0.5 |
| 8 | 150 | 20 | 8 | 8 | 2 | 0.5 |
| 9 | 150 | 20 | 8 | 8 | 2 | 0.5 |
| 10 | 150 | 20 | 8 | 8 | 2 | 0.5 |
| 11 | 180 | 20 | 3 | 2.5 | 2 | 0.7 |
| 12 | 180 | 20 | 7 | 6.5 | 2 | 0.7 |
| 13 | 180 | 20 | 7 | 6.5 | 2 | 0.7 |

TABLE 4
Experimental Results for CE1-CE11 and Examples 1-13

| | Flexural | TEC | Edge Lift | Specific | Specific |
|---|---|---|---|---|---|
| | Modulus | (×10⁻⁵ m/ | at 25° C. | Gravity | Modulus |
| Example | (MPa) | (m*° C.)) | (mm) | (g/cm³) | (MPa/(g/cm³)) |
| CE1 | 300 | 1.12 | 0 | 0.35 | 857 |
| CE2 | 390 | 0.69 | 0 | 0.40 | 975 |
| CE3 | 473 | 1.10 | 0 | 0.45 | 1051 |
| CE4 | 340 | 0.10 | 4 | 0.75 | 453 |
| CE5 | 720 | 0.47 | 3 | 0.70 | 1028 |
| CE6 | 290 | 0.23 | 3 | 0.61 | 475 |
| CE7 | 700 | 0.45 | 3 | 0.78 | 897 |
| CE8 | 1900 | 0.70 | 1 | 0.69 | 2753 |
| CE9 | 1040 | 1.9 | 2 | 0.67 | 1552 |
| CE10 | 473 | 0.67 | 0 | 0.36 | 1327 |
| CE11 | 236 | 0.16 | 0 | 0.28 | 831 |
| 1 | 2570 | 0.94 | <0.1 | 0.56 | 4589 |
| 2 | 3170 | 0.70 | <0.1 | 0.54 | 5870 |
| 3 | 1430 | 0.13 | <0.1 | 0.22 | 6520 |
| 4 | 1330 | 0.12 | <0.1 | 0.29 | 4586 |
| 5 | 2245 | 0.15 | <0.1 | 0.61 | 3680 |
| 6 | 2765 | 0.12 | <0.1 | 0.64 | 4320 |
| 7 | 3280 | 0.25 | <0.1 | 0.65 | 5046 |
| 8 | 690 | 0.70 | <0.1 | 0.45 | 1533 |
| 9 | 1310 | 1.30 | <0.1 | 0.50 | 2620 |
| 10 | 1030 | 0.81 | <0.1 | 0.54 | 1907 |
| 11 | 6217 | 2.09 | <0.1 | 0.97 | 6427 |
| 12 | 4398 | 2.09 | <0.1 | 0.74 | 5909 |
| 13 | 1861 | 1.19 | <0.1 | 0.57 | 3253 |

Having thus described particular embodiments, those of ordinary skill in the art will readily appreciate that the teachings found herein may be applied to yet other embodiments within the scope of the claims hereto attached.

What is claimed is:

1. A lightweight multilayer substrate comprising:
a thermally compressed nonwoven core having a first surface and an opposed second surface;
at least one top layer adhered to the first surface of the thermally compressed nonwoven core; and
optionally, at least one bottom layer adhered to the opposed second surface of the thermally compressed nonwoven core;
wherein the lightweight multilayer substrate has a specific modulus greater than 1200 (MPa/(g/cm³)) and a thermal expansion coefficient of less than 3×10⁻⁵ m/(m*° C.); and
wherein the lightweight multilayer substrate is thermally balanced between 25° C. and 70° C.

2. The lightweight multilayer substrate of claim 1, wherein the thermally compressed nonwoven core comprises at least one thermoplastic fiber layer.

3. The lightweight multilayer substrate of claim 1, wherein the at least one top layer comprises a reinforcing layer, an antiskid layer, or a combination thereof.

4. The lightweight multilayer substrate of claim 3, wherein the at least one bottom layer comprises a reinforcing layer, an antiskid layer, or a combination thereof.

5. The lightweight multilayer substrate of claim 1, wherein the lightweight multilayer substrate has a specific gravity of less than 0.80 g/cm³.

6. The lightweight multilayer substrate of claim 1, wherein the lightweight multilayer substrate has a specific gravity of less than 0.65 g/cm³.

7. The lightweight multilayer substrate of claim 1, wherein the lightweight multilayer substrate has an edge lift of less than 0.50%.

8. The lightweight multilayer substrate of claim 1, wherein the lightweight multilayer substrate has an edge lift of less than 0.25%.

9. The lightweight multilayer substrate of claim 3, wherein the reinforcing layer is a unidirectional tape.

10. The lightweight multilayer substrate of claim 3, wherein the reinforcing layer is an aluminum film or sheet.

11. The lightweight multilayer substrate of claim 3, further comprising a tie-layer between the thermally compressed nonwoven core and the reinforcing layer and/or the antiskid layer.

12. A lightweight multilayered article comprising:
a lightweight multilayered substrate derived from a thermally compressed nonwoven core having a first surface and an opposed second surface, at least one top layer adhered to the first surface of the nonwoven core, and optionally, at least one bottom layer adhered to the opposed second surface of the nonwoven core;
wherein the lightweight multilayered substrate has a specific modulus greater than 1200 (MPa/(g/cm³)) and a thermal expansion coefficient of less than 3×10⁻⁵ m/(m*° C.); and
wherein the lightweight multilayered substrate is thermally balanced between 25° C. and 70° C.

13. The lightweight multilayer article of claim 12, wherein the thermally compressed nonwoven core comprises at least one thermoplastic fiber layer.

14. A method for producing a lightweight multilayer substrate comprising the steps of:
(a) bonding thermoplastic fibers together to create at least one thermoplastic fiber layer;
(b) compressing the at least one thermoplastic fiber layer to create a nonwoven core having a first surface and an opposed second surface;
(c) forming a substrate wherein at least one top layer is placed onto the first surface of the nonwoven core and, optionally, at least one bottom layer is placed beneath the opposed second surface of the nonwoven core; and
(d) bonding the at least one top layer, the nonwoven core, and, optionally, the at least one bottom layer together via thermal compression to create the lightweight multilayer substrate;
wherein the lightweight multilayer substrate has a specific modulus greater than 1200 (MPa/(g/cm³)) and a thermal expansion coefficient of less than 3×10⁻⁵ m/(m*° C.); and
wherein the lightweight multilayer substrate is thermally balanced between 25° C. and 70° C.

15. The method for producing a lightweight multilayer substrate of claim 14, wherein the thermal compression is done on a continuous double belt press.
